(19) United States
(12) Patent Application Publication
(10) Pub. No.: US 2006/0198540 A1
(43) Pub. Date: Sep. 7, 2006

(54) Apparatus for mixing, controlling and distributing audio signals

(76) Inventor: Paul Erik Jonson, Tulock, CA (US)

Correspondence Address: WHITE-WELKER & WELKER, LLC, P.O. BOX 199, CLEAR SPRING, MD, 21722-0199, US

(21) Appl. No.: 11/346,976

(22) Filed: Feb. 4, 2006

Related U.S. Application Data
(60) Provisional application No. 60/650,288, filed on Feb. 4, 2005.

(51) Int. Cl. H04B 1/00; H04R 5/00

(52) U.S. Cl. 381/119; 381/1

(57) ABSTRACT

The apparatus of the present invention enables a plurality of inputs to be blended into a single stereo output with volume controls on each input. There is provided a mixing apparatus which comprises: one multi-channel input leading to one multi-channel output and one stereo output wherein the multi-channel output and the stereo output will need to have individual mute buttons. Mixing is accomplished via line level audio for completing the basic task of enabling a user to make use of their computer audio system to listen to other external apparatus. Users are also able to direct the audio output to the desired sound source, either external speakers or headphones. To accomplish this, the apparatus of the present invention's stereo out jack is connected to an auxiliary terminal on the sound card of the computer system while the line level audio out jacks from the sound car are connected to the multi-channel inputs on the apparatus of the present invention. The multi-channel output form the apparatus of the present invention is connected to the inputs on the amplifier of the computer system. Headphones are connected to the headphone out terminal on the apparatus of the present invention.
FIG. 14 illustrates how the device is connected to the various devices.
External audio devices are connected to Audio inputs (101, 102, 103, 104). These external audio signals are adjusted using volume controls (901, 902, 903, 904) or muted using Mute buttons (1001, 1002, 1003, 1004). These external audio signals are mixed into a single audio signal using a mixing circuit (601). The mixed signal is sent to a stereo output connector (201).

The mixed signal connector (201) is connected to the computers soundcard's (701) auxiliary input connection (801). Output from the computer's soundcard (802, 803, 804) is connected back to the device via 3 connectors (201, 202, 203). A switch or knob (501) directs the audio signal to either the devices speaker output connectors (301, 302, 303) or the devices headphone connector (401).

### CROSS REFERENCE TO RELATED APPLICATIONS

This application claims priority from U.S. Provisional Patent Application Ser. No. 60/650,288, entitled “Apparatus for Mixing, Controlling, and Distributing Audio Signals”, filed on Feb. 4, 2005.

### FEDERALLY SPONSORED RESEARCH

Not Applicable

### SEQUENCE LISTING OR PROGRAM

Not Applicable

### TECHNICAL FIELD OF THE INVENTION

The present invention relates generally to mixers for mixing audio signals and distributing the mixed audio signals. More specifically the present invention relates to a apparatus for mixing audio signals and controlling the mixing and distributing of such audio signals.

### BACKGROUND OF THE INVENTION

Conventionally, mixing apparatus are known which are capable of mixing audio signals supplied from a plurality of sound sources. In the current state of the prior art mixers are used widely in a variety of applications and come in various types to meet various demands.

It is not uncommon for a user to have two or more personal computers in their office and in use during the regular course of business. For simplicity, multi-computer user apparatus have been developed which enables a user interact with each individual computer through a single keyboard, mouse, and monitor. Such apparatus known in the prior art have yet to address the need for a user to hear noises or sounds emanating or being produce by an individual machine through a central speaker system whether it is selected as the computer current being accessed by the multi-computer user apparatus.

The emergence of portable music apparatus such as Sony's Walkman which play cassettes, Rio Players, iPods, and portable satellite radio systems have created a need for enabling a user to quickly and easily connect such apparatus to a computer so that the user can listen to their sounds via the computer audio equipment, which may be of much better quality than that of the portable apparatus. Some potable apparatus, such as a Walkman use older technology such as a tape cassette, which are not compatible with the majority of home and business computer systems on the market today or must connect directly to the computer terminals which are inconvenient for a user as they are often located on the back side of the computer system that may be located under a desk. As such, a user desiring to listen to external audio sources when they are new or older technology through their computers audio system has no current apparatus that provides the ease of access and options as the present invention.

Other apparatus such as the iPod and Rio Player are compatible with today's home and office computer systems, but the increased number of peripheral apparatus is already occupying many of the available connectors on the computer system which causes a user to have to unplug apparatus to plug in a portable external apparatus for listening to audio. Additionally, many users have invested a great deal of time and energy developing a quality speaker system on their home or office computer which is typically much better that the speakers and sound system built into the portable apparatus themselves or headphones.

For the foregoing reasons, conventional mixing apparatus known in the prior are not provided with functionality for enabling a user to be positively engaged in the audio system of a user's computer system.

In many situations, the computer system is located in a position such that the user may not be able to always play the music or other sounds emanating from his computer and other audio equipment at the volume levels they desire. Many home computers are located in a central location in the home, often near the family television or other shared location. At times, the sounds from the computer will conflict with the other sounds in the environment. A means to easily re-direct the audio signal to headphones is desired.

### SUMMARY OF THE INVENTION

In accordance with the present invention a method for mixing and controlling audio signals is provided which overcomes the aforementioned problems of the prior art. It is therefore an object of the present invention to provide a mixer which can fulfill the above-mentioned demand and yet be economical and simple in construction.

The apparatus of the present invention enables a plurality of inputs to be blended into a single stereo output with volume controls on each input. The user would select one of these input sources to be directed to the single stereo output. In the base configuration of this device, there is no “mixing” provided by the device. The computer's sound card would provide the mixing function by combining the audio signal output from this device via the sound cards auxiliary input with the other audio signals being processed by the PC.

To accomplish this simple task, the apparatus of the present invention's stereo out jack is connected to an auxiliary terminal on the sound card of the computer system while the line level audio out jacks from the sound car are connected to the multi-channel inputs on the apparatus of the present invention. The multi-channel output from the apparatus of the present invention is connected to the inputs on the amplifier of the computer system's speaker system. Headphones are connected to the headphone out terminal on the apparatus of the present invention. The user selects where the audio output is directed, either to the speakers or the headphones.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a back view of a physical embodiment of the mixer in accordance with a first embodiment of the present invention;

FIG. 2 illustrates a top view of a physical embodiment of the mixer in accordance with a first embodiment of the present invention;

FIG. 3 illustrates a front view of a physical embodiment of the mixer in accordance with a first embodiment of the present invention;

FIG. 4 is a diagram illustrating a plurality of inputs combined into a single output;

FIG. 5 is a diagram illustrating the mixing of a plurality of inputs to a plurality of outputs;

FIG. 6 illustrates a back view of a physical embodiment of the mixer in accordance with a second embodiment of the present invention;

FIG. 7 illustrates a front view of a physical embodiment of the mixer in accordance with a second embodiment of the present invention;

FIG. 8 illustrates a back view of a physical embodiment of the mixer in accordance with a third embodiment of the present invention;

FIG. 9 illustrates a front view of a physical embodiment of the mixer in accordance with a third embodiment of the present invention;

FIG. 10 illustrates a top view of a physical embodiment of the mixer in accordance with a third embodiment of the present invention;

FIG. 11 illustrates a front view of a physical embodiment of the mixer in accordance with a fourth embodiment of the present invention;

FIG. 12 illustrates a top view of a physical embodiment of the mixer in accordance with a fourth embodiment of the present invention;

FIG. 13 illustrates a top view of a physical embodiment of the mixer in accordance with a fourth embodiment of the present invention; and

FIG. 14 illustrates the mixer in combination with a PC sound card and potential inputs and output devices.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

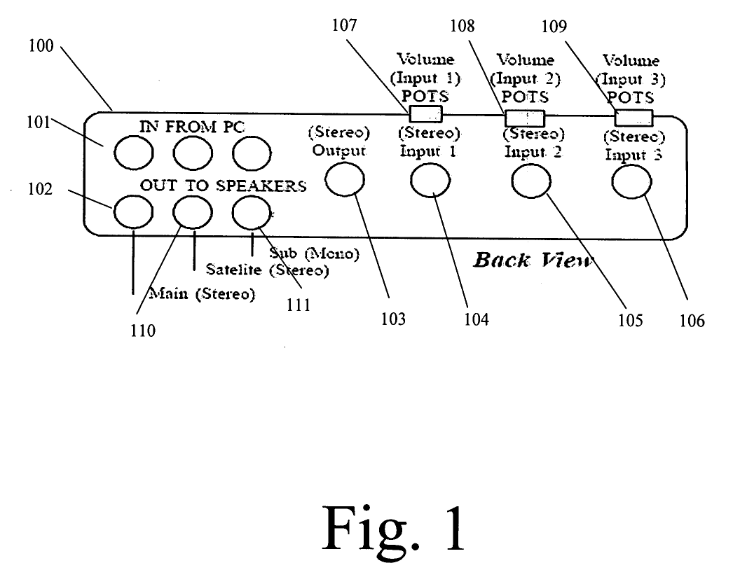

Now referring to FIG. 1 which illustrates a back view (101) of a physical embodiment of the mixer (100) in accordance with a first embodiment of the present invention. The physical embodiment of the mixer (100) is comprised of a plurality of computer input terminals (101) and a plurality of output terminals to the one or more audio systems such as a main stereo (102), satellite (110), or sub system (111). A plurality of stereo inputs (104, 105, & 106) blended into a single stereo output (103) with volume controls (107, 108, & 109) for each respective stereo input (104, 105, & 106).

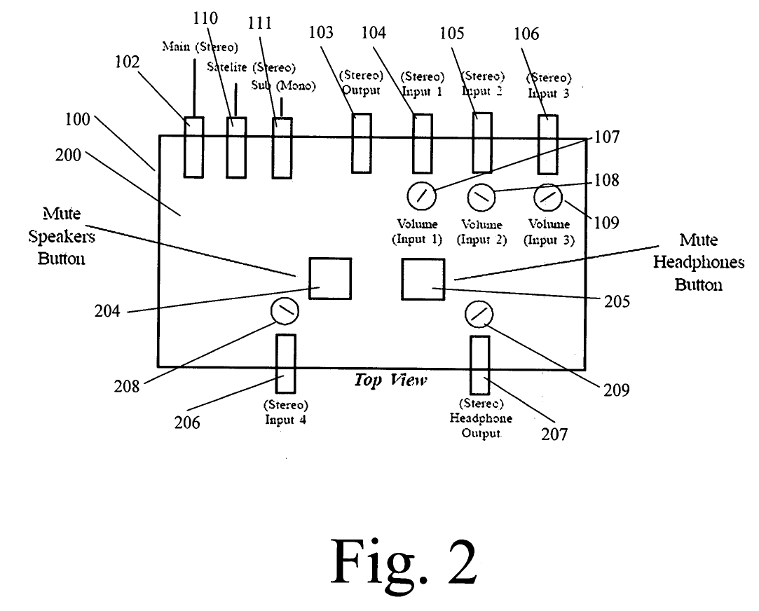

FIG. 2 illustrates a top view of a physical embodiment of the mixer (100) in accordance with a first embodiment of the present invention. Again it is shown that on the back side (101) of the apparatus a plurality of stereo inputs (104, 105, & 106) are blended into a single stereo output (103) wherein the volume controls (107, 108, & 109) for each respective stereo input (104, 105, & 106) are place on the top side (200) of the mixing apparatus and are accessible to a user. Additionally, a mute speakers button (204), a mute headphones button (205), volume control (208) for an additional stereo input (206), and volume control (209) for the headphone output (207) are also located on the top side (200) of the mixing apparatus.

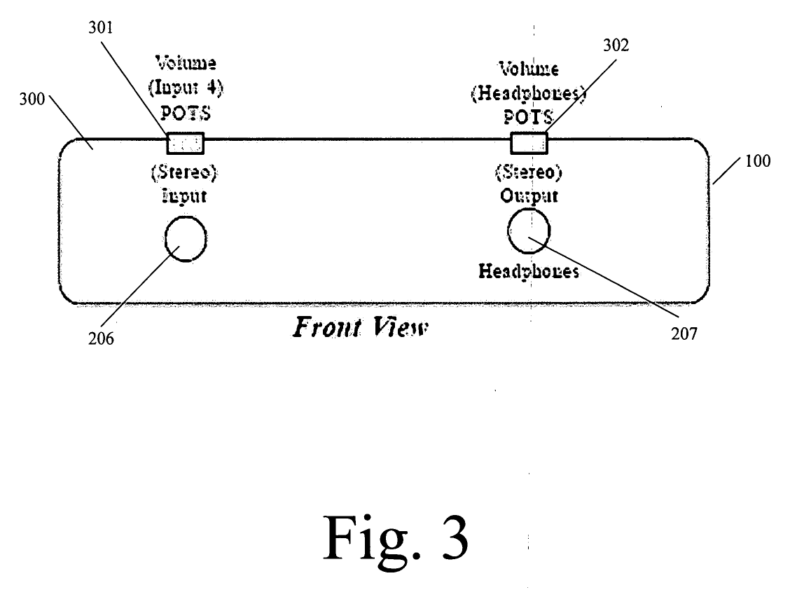

Now referring to FIG. 3 a front view of a physical embodiment of the mixer in accordance with a first embodiment of the present invention is illustrated. On the front face (300) of the physical embodiment of the apparatus of the present invention (100) a stereo input (206) and stereo headphone output (207) are provided. Volume control (301) for the stereo input (206) as well as a volume control (302) for the headphone output (207) are provided.

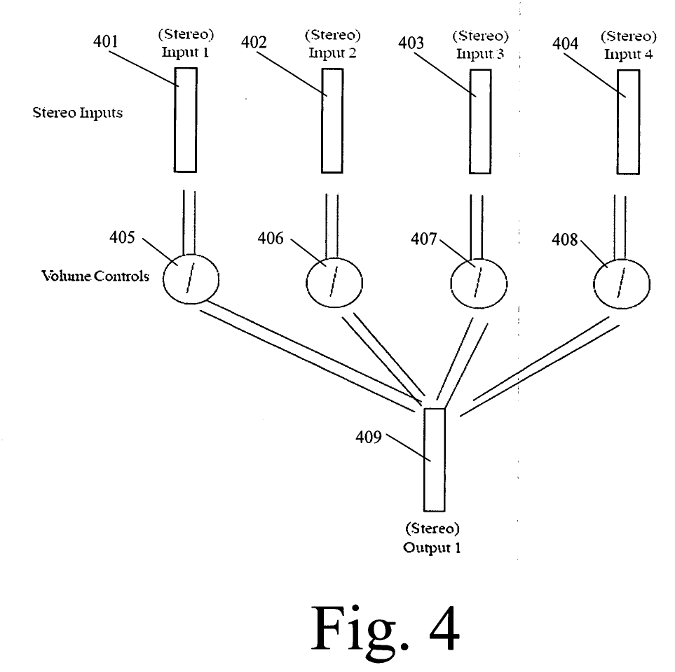

FIG. 4 is a illustrating how a plurality of inputs are directed to a single output by the apparatus of the present invention. Initially a plurality of inputs (401, 402, 403, & 404) are connected to the apparatus. Once connected each input is controlled by its own respective volume control (405, 406, 407, & 408) which may be manually controlled by the use through an external apparatus such as a button or dial. The plurality of inputs (401, 402, 403, & 404) are then directed to a single output (409) whose audio is determined by the settings of each volume control (405, 406, 407, & 408). In once embodiment of the present invention does not provide for the actual mixing of the input signals and their respective circuits, but only allows selection of individual inputs to the single output (409). Other embodiments of the invention are considered wherein multiple inputs are actually mixed which enables a user to select an external source from a plurality of input sources.

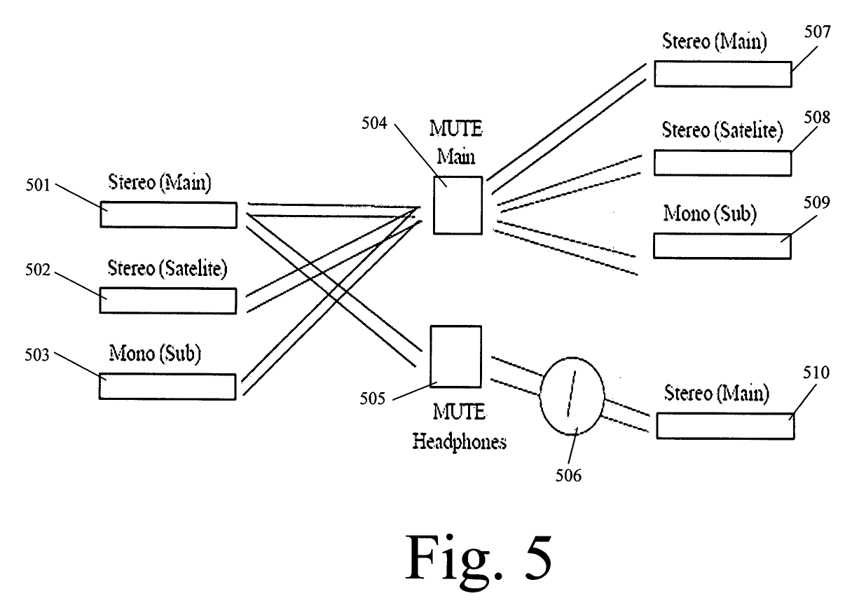

Now referring to FIG. 5 is a diagram illustrating the mixing of a plurality of inputs to a plurality of outputs. First a plurality of inputs (501, 502, & 503) from the computer system are provided which may be sent directly to the main stereo headphone output (510) via a selection control (505) and a volume control (506). Alternatively, the plurality of inputs (507, 508, & 509) from the computer system may be sent via a selection control (504) which can select each of said plurality of inputs (507, 508, & 509) from the computer system individually to the main stereo headphone output (510) via a second selection control (505) for the main stereo headphone output (510) and a volume control (506). This preferred embodiment does not incorporate the use of mute controls or buttons, and utilizes only one output destination but it should be appreciated that the incorporation of multiple output destinations and/or the use of mute controls will occur in other embodiments.

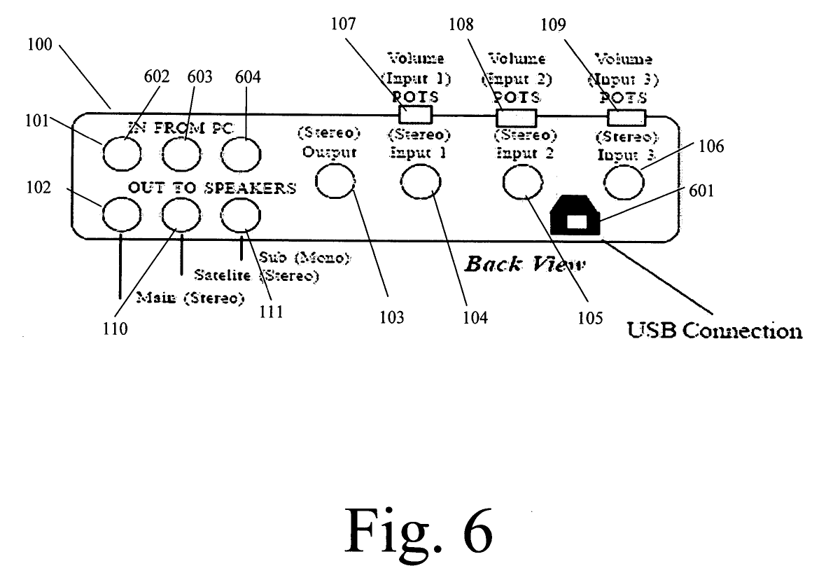

Now referring to FIG. 6 a back view of a physical embodiment of the mixer (100) in accordance with a second embodiment of the present invention is provided. The physical embodiment of the mixer (100) is comprised of a plurality of computer input terminals (101) such as a main stereo (602), satellite (603), or sub system (604) and a plurality of out terminals to the one or more audio systems such as a main stereo (102), satellite (110), or sub system (111). A plurality of stereo inputs (104, 105, & 106) blended into a single stereo output (103) with volume controls (107, 108, & 109) for each respective stereo input (104, 105, & 106). Additionally, in this second embodiment, a USB connection (601) is provided for connecting to the computer system. The use of a USB terminal in this second embodiment is representative of evolving technology and changes that occur in terminal architecture for computer system connectivity.

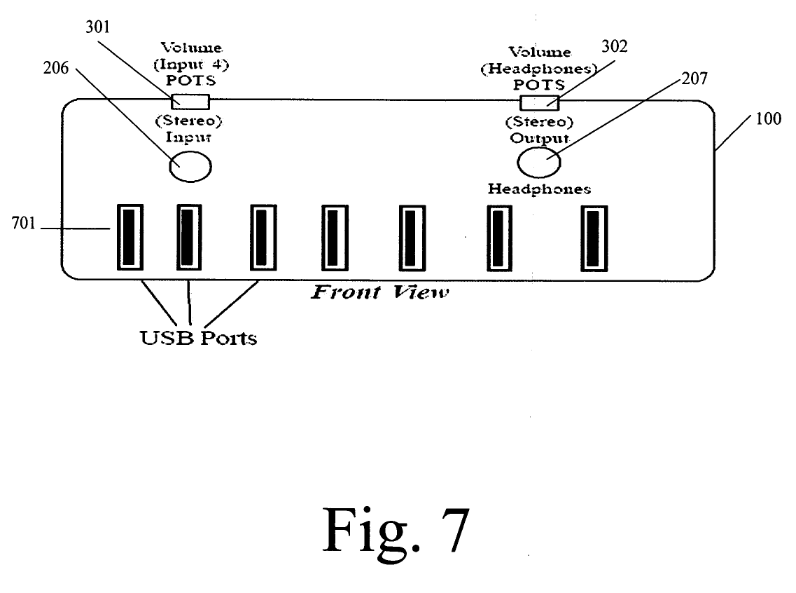

FIG. 7 illustrates a front view of a physical embodiment of the mixer (100) in accordance with a second embodiment of the present invention. On the front face (300) of the physical embodiment of the apparatus of the present invention (100) a stereo input (206) and stereo headphone output (207) are provided. Volume control (301) for the stereo input (206) as well as a volume control (302) for the headphone output (207) are provided. Additionally, in this second embodiment, a plurality of USB connections (701) are provided for creating a general purpose USB hub for connecting any USB apparatus to the computer system. This feature has been incorporated to provide more functionality the mixer of the present invention that is likely to be place on a user's desktop and eliminate the need for more apparatus on the desktop, as it is believe most users of this product would most likely need a USB hub as well to serve their computer system requirements. Alternatively, the plurality of USB connections (701) could be used for connecting a plurality of external audio apparatus to the mixing apparatus of the present invention or creating additional audio inputs and outputs.

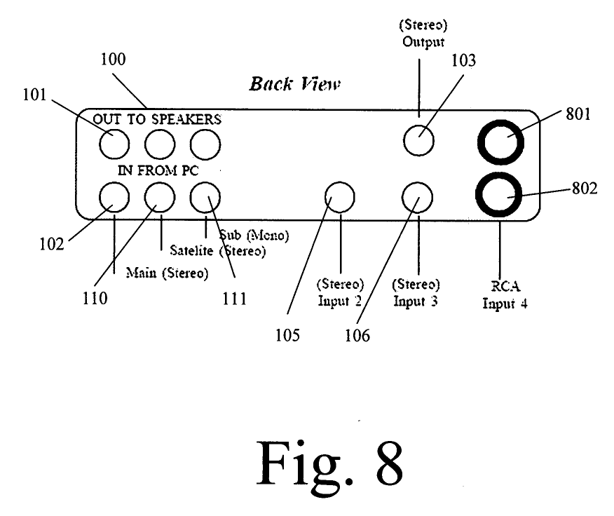

Now referring to FIG. 8 a back view of a third embodiment of the present invention is illustrated. In this third embodiment the mixer (100) is comprised of a plurality of computer input terminals (101) and a plurality of output terminals to one or more audio systems such as a main stereo (102), satellite (110), or sub system (111). A plurality of stereo inputs (105, & 106) are blended into a single stereo output (103) and one set of two RCA connectors (801 & 802) with volume controls (901, 902, 903, & 904) for each respective stereo input (104, 105, & 106).

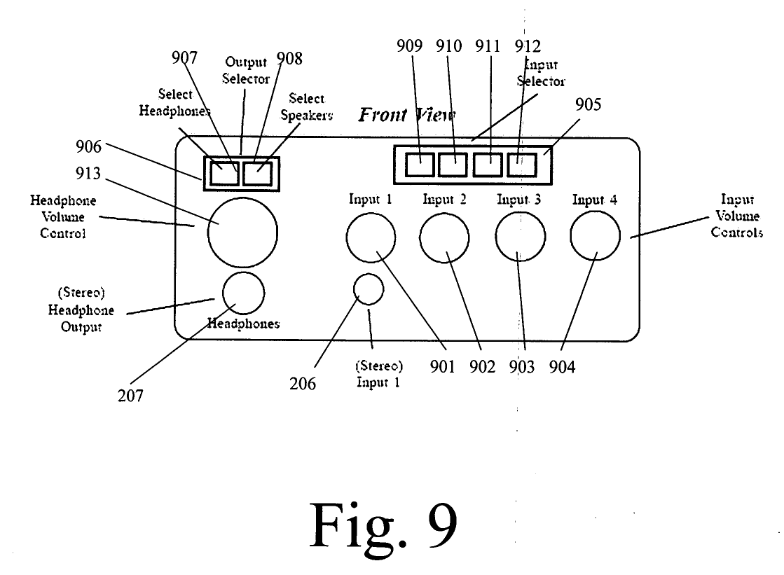

Referring to FIG. 9, the user can choose one of the four inputs via a switch (905) that allows only one input to be selected. By selecting input 1, input 2, 3 and 4 are deselected. By choosing input 2, inputs 1,3, and 4 are deselected, and so forth. All inputs are two channel stereo inputs. All of the inputs have independent volume controls (901, 902, 903, & 904). The volume controls (901, 902, 903, & 904) allow the users to match the various input levels. In the apparatus, the inputs are routed to the single stereo output (206) or the multi-channel output (101). The apparatus has a two-way button (906) that allows the user to select the desired output source. The output selection button (906) selects if the output is directed to the speaker system via the multi-channel terminals (908) or the ¼″ headphone jack (907).

In this configuration, no “mixing” is performed. The apparatus acts as an input and output selection apparatus. This embodiment of the apparatus lets the user selects which other external audio source will be directed to the computers auxiliary input. This embodiment also allows the user to select where the audio source is directed, either the speaker system or the headphones.

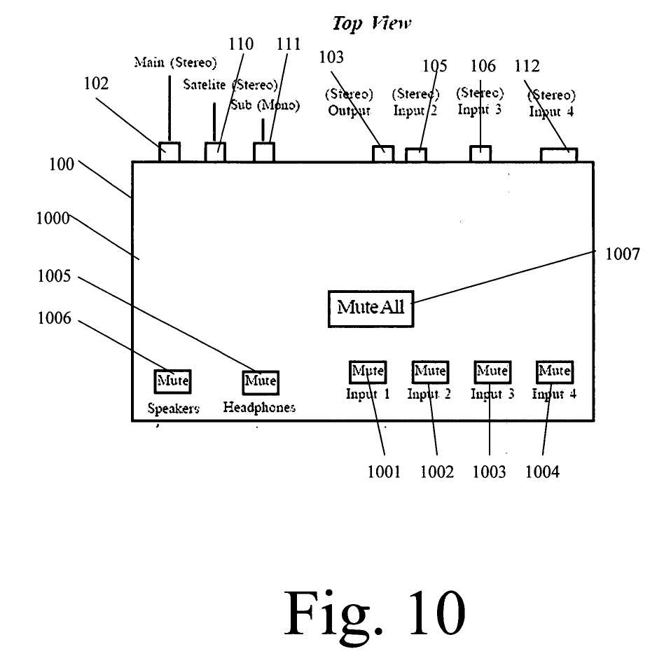

Now referring to FIG. 10 the apparatus mixes the various stereo inputs (105, 106, 112) into a single stereo output (103). All of the input and output terminals remain the same. The changes to the apparatus include the replacement of the input selector button (907) with a series of mute buttons (1001, 1002, 1003, 1004). The user can mute or un-mute each of the various input sources (105, 106, 112) individually or all via the mute all button (1007). There is still a volume control (901, 902, 903, & 904) for each of the input sources (105, 106, 112). Output is selected by a selection button (906) for depressing either the button for the headphones (907) or the button for the speakers (908). A mute all button is added to the two output selections (1005 & 1006). Rather than select the desired output from the two choices, the user selects where the output is directed using a source button. The user also has a mute button for each output (1005 & 1006).

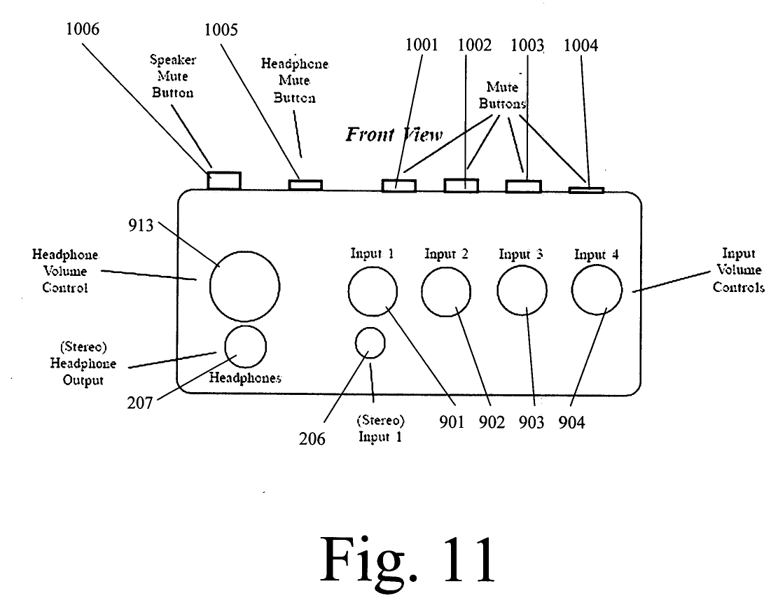

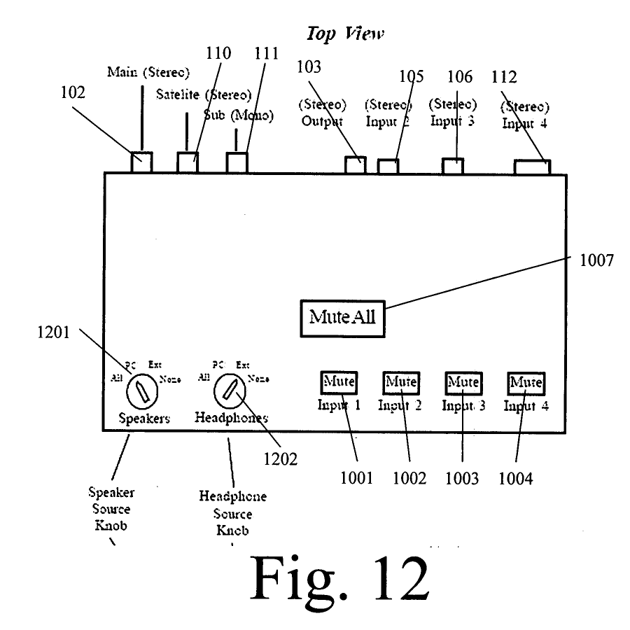

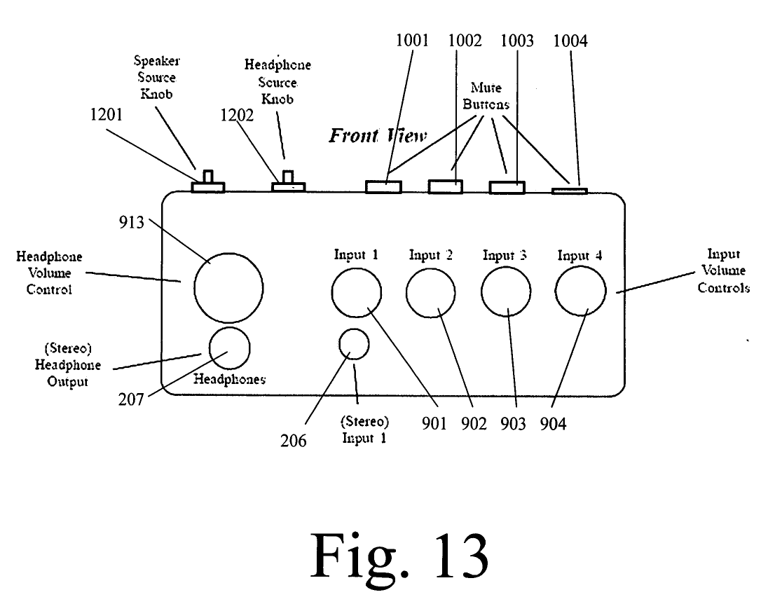

In a fourth embodiment illustrated by FIGS. 11-13, the apparatus is modified to allow a user to direct the internal and computer input sources to different output terminals. A source button directing signals to the multi-channel output terminal (1201) from either the multi-channel input terminal, plurality of stereo input terminals, all input terminals, or selecting no signal and a source button directing signals to the stereo output terminal (1202) from either the multi-channel input terminal, plurality of stereo input terminals, all input terminals, or selecting no signal.

The user can direct an audio source from a computer to the speakers while directing the audio source from the four external audio sources to the headphones. The outputs can be swapped so that the external audio sources are directed to the headphones while the computer audio is directed to the speakers. The user could play a computer game using his headphones for game play while playing music through the computer's speakers. Or, the user can have music playing from his computer through the speakers while listening more closely to one of the external audio sources through the headphones.

Another embodiment includes the blending of the various inputs via a mixing circuit combined with a simple output selector that allows the user to select either the speakers or the headphones as the desired output for the combined audio output. Each input would have a volume and mute controls.

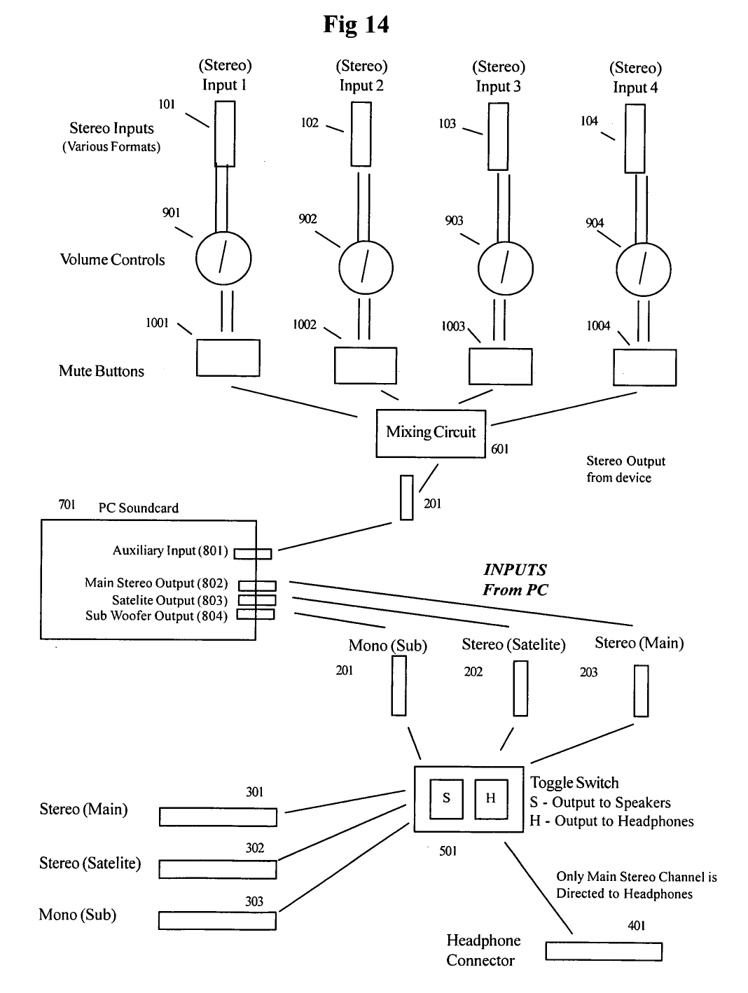

Now referring to FIG. 14, the device (201) includes a mixing circuit (601) which is comprised of a plurality of mute buttons (1001, 1002, 1003, and 1004) each have their own corresponding volume controls (901, 902, 903, 904) and inputs (101, 102, 103, and 104). The device (210) is connected to a PC sound card (701) which is comprised of an auxiliary input (801), a main stereo ouput (802), a satelite output (803), and a sub woofer output (804) which are each connected tto corresponding inputs from the PC (201, 202, and 203). A toggle switch (501) controls output between speakers and headphones. At this time only the main stereo channel is directed to the headphones via the headphone connector 401, while the the main stereo (301), satelite (302) and mono sub (303) outputs can all be directed to speakers.

In each of these embodiments, there is the option of including a USB hub in the case. The USB hub would have one input and multiple outputs. Any of these embodiments that include a USB hub will require a power source. In addition, any apparatus using a USB hub or providing the actual mixing of signals will also require a power source since there is active mixing that occurs in the apparatus.

In an alternative embodiment there is a video pass through allowing a user to connect RCA, s-video, component, or HiDefinition video through the device while redirecting the audio signals straight through or to headphones or a separate audio device such as an external speaker system or speakers. An example for this use is gaming systems that connect to televisions or other display devices. Gaming stations to include the xBox, GameCube, PlayStation or other gaming systems.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A signal processing apparatus comprising:
a multi-channel input terminal and a plurality of stereo input terminals that receive signals from external sources;
a multi-channel output terminal distributing said signals received from said multi-channel input terminal to an external apparatus;
a stereo output terminal distributing the signal received from a selected stereo input terminal to an external apparatus;
a plurality of RCA connector input terminals receiving signals from external apparatus;
a plurality of other audio connectors yet to be determined;
switch for selecting an individual stereo input terminal;
individual volume control for each of said plurality of stereo input terminals; and
two-way button directing output to either the stereo output terminal or the multi-channel output terminal.

2. A signal mixing apparatus comprising:
a power source;
a multi-channel input terminal and a plurality of stereo input terminals that receive signals from external sources;
a multi-channel output terminal distributing said signals received from said multi-channel input terminal to an external apparatus;
a stereo output terminal distributing the signal received from a selected stereo input terminal to an external apparatus;
a plurality of RCA connector input terminals receiving signals from external apparatus;
a plurality of other audio connector input terminals receiving signals from external apparatus;
a plurality of selectable mute buttons corresponding individually to each of said plurality of stereo input terminals, stereo output terminal, and the multi-channel output terminal;
individual volume control for each of said plurality of stereo input terminals; and
two-way button directing output to either the stereo output terminal or the multi-channel output terminal.

3. A signal mixing apparatus comprising:
a power source;
a multi-channel input terminal and a plurality of stereo input terminals that receive signals from external sources;
a multi-channel output terminal distributing said signals received from said multi-channel input terminal to an external apparatus;
a stereo output terminal distributing the signal received from a selected stereo input terminal to an external apparatus;
a plurality of RCA connector input terminals receiving signals from external apparatus;
a plurality of other audio connector input terminals receiving signals from external apparatus;
a plurality of selectable mute buttons corresponding individually to each of said plurality of stereo input terminals, stereo output terminal, and the multi-channel output terminal;
individual volume control for each of said plurality of stereo input terminals; and
source button directing signals to the multi-channel output terminal from either the multi-channel input terminal, plurality of stereo input terminals, all input terminals, or selecting no signal;
source button directing signals to the stereo output terminal from either the multi-channel input terminal, plurality of stereo input terminals, all input terminals, or selecting no signal.

4. The apparatus of claims 1, 2, or 3 wherein said multi-channel input terminals are comprised of three stereo input terminals and said multi-channel output terminals are comprised of three stereo output terminals.

5. The apparatus of claims 1, 2, or 3 wherein connections from a computer's sound card are connected to the multi-channel input terminals and the multi-channel output terminals are connected to the input terminals of an amplified speaker system.

6. The apparatus of claims 1, 2, or 3 comprising four or more stereo input terminals and two or more stereo output terminals.

7. The apparatus of claims 1, 2, or 3 wherein said plurality of stereo input terminals comprises three ⅛ inch stereo inputs and two RCA connector inputs.

8. The apparatus of claims 1, 2, or 3 wherein said plurality of stereo output terminals comprises a ¼ inch headphone jack and a ⅛ inch stereo connection terminal.

9. The apparatus of claim 8 wherein said ⅛ inch stereo connection terminal is connected to a computer's auxiliary input terminal.

10. The apparatus of claims 1, 2, or 3 wherein all inputs are two channel stereo input terminals.

11. The signal mixing apparatus of claim 2 comprising a button for muting all of said plurality of stereo input terminals, stereo output terminal, and the multi-channel output terminal.

12. The apparatus of claim comprising a power source and a USB hub having one input and a plurality of outputs.

13. The apparatus of claims 2 or 3 comprising a USB hub having one input and a plurality of outputs.

14. The apparatus of claims 1, 2, or 3 further comprising a video pass through allowing a user to connect RCA, s-video, component, or HiDefinition video through said apparatus while redirecting the audio signals straight through the device or to a separate audio device.
